(19) United States
(12) Patent Application Publication
(10) Pub. No.: US 2007/0046652 A1
(43) Pub. Date: Mar. 1, 2007

(54) Touch panel

(76) Inventors: Shoji Fujii, Osaka (JP); Koji Tanabe, Osaka (JP); Kenichi Matsumoto, Osaka (JP)

Correspondence Address: RATNERPRESTIA, P.O. BOX 980, VALLEY FORGE, PA, 19482, US

(21) Appl. No.: 11/508,434

(22) Filed: Aug. 23, 2006

(30) Foreign Application Priority Data
Aug. 31, 2005 (JP) 2005-251158

(51) Int. Cl. G09G 5/00

(52) U.S. Cl. 345/176

(57) ABSTRACT

A touch panel including a light-transmissive upper substrate, a light-transmissive lower substrate, an upper wave plate, a polarizing plate, a lower wave plate, and a first cover layer. An upper conductive layer is formed at a lower face of the upper substrate, and a lower conductive layer is formed at a top face of the lower substrate. This lower conductive layer is formed facing the upper conductive layer with a predetermined space in between. The upper wave plate is formed at a top face of the upper substrate. The polarizing plate is formed at a top face of the upper wave plate. The lower wave plate is formed at a lower face of the lower substrate. The first cover layer is formed at a lower face of the lower wave plate. This structure offers a touch panel which is resistant to damage to the lower wave plate and provides good viewability.

### BACKGROUND OF THE INVENTION

1. Field of the Invention

The present invention relates to touch panels for operating electronic devices.

2. Background Art

With electronic devices such as mobile phones and car navigation systems becoming increasingly sophisticated and diversified, many products are adopting a light-transmissive touch panel on a front face of a display device, typically a liquid crystal display. The user of the electronic device views what is displayed on the display device on a rear face of the touch panel through this touch panel, and presses the touch panel typically with a finger or pen so as to operate it and switch between the functions of the electronic device. Accordingly, the user requires a touch panel with good viewability and reliable operation.

A conventional touch panel is described next with reference to FIG. 4.

FIG. 4 is a sectional view of the conventional touch panel. In FIG. 4, upper substrate 101 is a light-transmissive film, typically made of polycarbonate resin. Lower substrate 102 is also light-transmissive. Light-transmissive upper conductive layer 103, made typically of indium tin oxide, is formed on a lower face of upper substrate 101. Optically transparent lower conductive layer 104, made typically of indium tin oxide, is formed on a top face of lower substrate 102.

Dot spacers (not illustrated) are formed, using insulting resin, at predetermined intervals on a top face of lower conductive layer 104. A pair of upper electrodes (not illustrated) is formed on both ends of upper conductive layer 103. A pair of lower electrodes (not illustrated) is formed on both ends of lower conductive layer 104 in a direction perpendicular to the upper electrodes.

An adhesive layer (not illustrated) is applied to upper and lower faces of frame-like spacer 105. This adhesive layer attaches upper substrate 101 and lower substrate 102 together by their outer borders. Accordingly, upper conductive layer 103 and lower conductive layer 104 are disposed facing each other with a predetermined space in between.

Upper wave plate 106 is a quarter-wave plate which is given birefringence by stretching a film typically of polycarbonate resin. Polarizing plate 107 is formed typically by laminating triacethyl cellulose film on top and lower faces of a stretched and oriented polarizer to which iodine and dye have been adsorbed in polyvinyl alcohol. Upper wave plate 106 and polarizing plate 107 are then laminated and attached to a top face of upper substrate 101.

Same as upper wave plate 106, lower wave plate 108 is a quarter-wave plate which is given birefringence by stretching a film typically of polycarbonate resin. This lower wave plate 108 is attached to a lower face of lower substrate 102 to configure touch panel 100.

Touch panel 100 is disposed on a front face of typically a liquid crystal display device (not illustrated), and then mounted on an electronic device (not illustrated). A pair of upper electrodes and a pair of lower electrodes are coupled to electronic circuit (not illustrated) of the electronic device.

A top face of polarizing plate 107 is pressed typically by a finger or pen while the user views what is displayed on the liquid crystal display device on a rear face of touch panel 100. This operation makes upper substrate 101 dent, together with polarizing plate 107 and upper wave plate 106, and upper conductive layer 103 and lower conductive layer 104 come into local contact at a portion pressed.

Then, the electronic circuit applies voltage sequentially to the upper electrodes and the lower electrodes. The electronic circuit detects a portion pressed based on the voltage ratio of the upper electrodes and the voltage ratio of the lower electrodes. This switches between the various functions of the electronic device.

External light, such as sunlight or lamplight irradiated from above touch panel 100, first passes through polarizing plate 107. When the external light passes through polarizing plate 107, light waves in the X direction and light waves in the Y direction perpendicular to the X direction are linearly polarized only to either direction by polarizing plate 107. For example, when polarizing plate 107 has the characteristic of absorbing light waves in the Y direction, only light waves of linearly polarized light in the X direction passes through polarizing plate 107. This light exits from polarizing plate 107, and enters upper wave plate 106. Light waves entering upper wave plate 106 are polarized from linearly polarized light to circularly polarized light as a result of passing through upper wave plate 106. Light waves of this circularly polarized light are reflected upward on lower conductive layer 104.

The light reflected on the surface of lower conductive layer 104 passes through upper wave plate 106 again. The light is now linearly polarized in the Y direction which is shifted by a half-wavelength, and enters polarizing plate 107. However, since polarizing plate 107 has the characteristic of passing through only the light waves in the X direction, polarizing plate 107 blocks any reflected light which is linearly polarized in the Y direction.

In other words, any external light entering touch panel 100 from above touch panel 100 is reflected upward on lower conductive layer 104. However, polarizing plate 107 blocks the light reflected on lower conductive layer 104, and thus this light does not exit from the top face of polarizing plate 107, which is the operation face. Accordingly, reflection of external light on the surface of touch panel 100 is eliminated, offering good viewability. The liquid crystal display device on the rear face of touch panel 100 is thus easily viewable.

Contrarily, for example, let's say the light typically of the liquid crystal display device disposed on the rear face of touch panel 100 is linearly polarized in the Y direction. In this case, the light first passes through lower wave plate 108 and then upper wave plate 106. This makes the light linearly polarized in the Y direction to become a light linearly polarized in the X direction which is shifted by a half-wavelength. This light enters polarizing plate 107, passes through polarizing plate 107, and exits from the top face of polarizing plate 107.

In other words, the light typically of the liquid crystal display device becomes linearly polarized in the X direction by passing through lower wave plate 108 and upper wave plate 106, only shifted by a half-wavelength, and is emitted from the top face of polarizing plate 107. Accordingly, touch panel 100 is configured to provide clear viewability of what is displayed typically on the liquid crystal display device on the rear face of touch panel 100.

Conventional touch panel 100 is typically disclosed in Japanese Patent Unexamined Publication No. 2000-10732.

### SUMMARY OF THE INVENTION

A touch panel of the present invention includes a light-transmissive upper substrate, a light-transmissive lower substrate, an upper wave plate, a polarizing plate, a lower wave plate, and a first cover layer. An upper conductive layer is formed at a lower face of the upper substrate. A lower conductive layer is formed at a top face of the lower substrate in a way such that the lower conductive layer faces the upper conductive layer with a predetermined space in between. The upper wave plate is formed at a top face of the upper substrate. The polarizing plate is formed at a top face of the upper wave plate, and the lower wave plate is formed at a lower face of the lower substrate. The first cover layer is formed at a lower face of the lower wave plate. This structure offers a touch panel which is resistant to damage that may occur to the lower wave plate and provides good viewability.

### BRIEF DESCRIPTION OF THE DRAWINGS

FIG. 1 is a plan view of a touch panel in a preferred embodiment of the present invention.

FIG. 2 is a sectional view of the touch panel in FIG. 1, taken along line 2-2.

FIG. 3 is a sectional view of the touch panel in another preferred embodiment of the present invention.

FIG. 4 is a sectional view of a conventional touch panel.

### DETAILED DESCRIPTION OF THE INVENTION

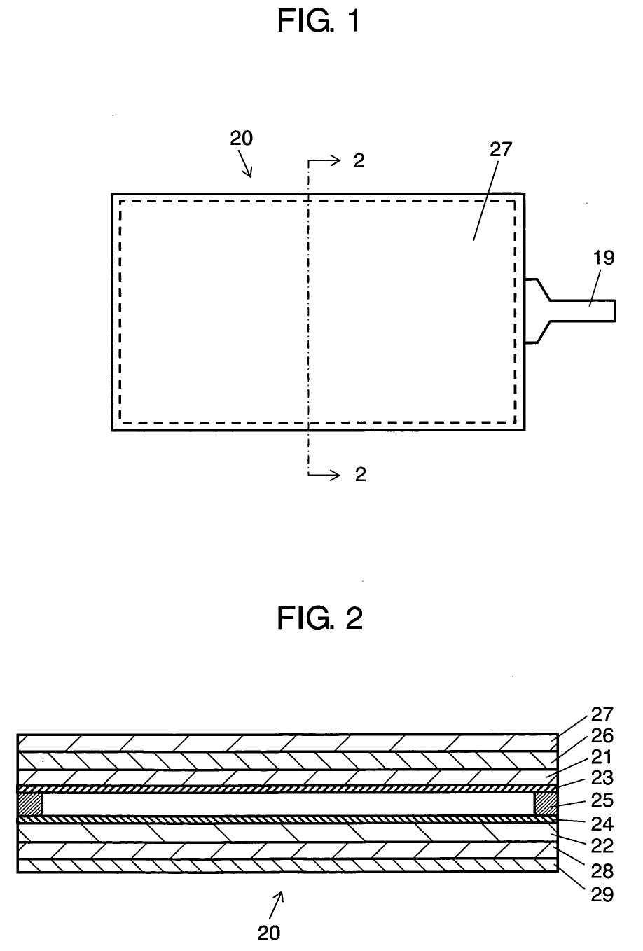

A preferred embodiment of the present invention is described below with reference to FIGS. 1 to 3.

### EMBODIMENT

FIG. 1 is a plan view of a touch panel in the preferred embodiment of the present invention. FIG. 2 is a sectional view of the touch panel shown in FIG. 1 taken along line 2-2. In FIGS. 1 and 2, upper substrate 21 is a light-transmissive film made of an optically isotropic material, typically polyethersulfone resin or polycarbonate resin. Light-transmissive lower substrate 22 is made of an optically isotropic material, typically glass, acrylic resin or polycarbonate resin. Light-transmissive upper conductive layer 23, made typically of indium tin oxide or tin oxide, is formed at a lower face of upper substrate 21. Light-transmissive lower conductive layer 24, made typically of indium tin oxide or tin oxide, is also formed at a top face of lower substrate 22. Upper conductive layer 23 and lower conductive layer 24 are formed typically using sputtering.

A plurality of dot spacers (not illustrated) are formed, using insulating resin typically epoxy resin or silicone resin, at predetermined intervals on a top face of lower conductive layer 24. A pair of upper electrodes (not illustrated), made typically of silver or carbon, are formed at both ends of upper conductive layer 23. A pair of lower electrodes (not illustrated), made typically of silver or carbon, are formed at both ends of lower conductive layer 24 in a direction perpendicular to the upper electrodes.

Wiring board 19 is film-shaped and is made typically of polyethylene terephthalate or polycarbonate resin. Wiring patterns (not illustrated) made typically of silver, carbon, or copper foil are formed on top and lower faces of wiring board 19. One end of each wiring pattern is coupled to the upper electrodes, lower electrodes, etc.

Frame-like spacer 25 is made of a material that is typically unwoven fabric or polyester film. An adhesive layers (not illustrated), typically of acrylic resin or rubber, which are applied to top and lower faces of spacer 25, attaches upper substrate 21 and lower substrate 22 together by their outer borders. Accordingly, upper conductive layer 23 and lower conductive layer 24 are disposed facing each other with a predetermined space in between. The term ‘frame-like shape’ refers to a polygon such as quadrangle in which only the outer border is formed like a frame.

Flexible upper wave plate 26 is a quarter-wave plate given birefringence by stretching a film typically of polycarbonate resin or cyclo-olefin polymer. Flexible polarizing plate 27 is formed typically by laminating a triacetyl cellulose film on top and lower faces of a stretched and oriented polarizer to which iodine and dye have been adsorbed in polyvinyl alcohol. Upper wave plate 26 and polarizing plate 27 are then laminated and attached to a top face of upper substrate 21, typically by acrylic adhesive (not illustrated).

Flexible lower wave plate 28 is a quarter-wave plate which is also formed using the same materials and methods as upper wave plate 26. Lower wave plate 28 is attached to a lower face of lower substrate 22 by adhesive (not illustrated). First cover layer 29 (hereinafter referred to as ‘layer 29’) is a hard-coating layer made typically of acrylic resin. Layer 29 has a light-transmissive characteristic, and is formed on a lower face of lower wave plate 28. Touch panel 20 is configured as above.

The hardness of layer 29 is H to H2 as measured by pencil hardness. It is harder than lower wave plate 28, which has HB pencil hardness. Here, the pencil hardness refers to the hardness measured in accordance with K5600-5-4 “Testing methods for paints—Part 5: Mechanical property of film—Section 4: Scratch hardness (Pencil method)” in JIS (Japan Industrial Standards). Damage to lower wave plate 28 can be suppressed by covering the lower face of lower wave plate 28 with layer 29. For example, provision of layer 29 is effective at times such as when touch panel 20 is manufactured, stored, or transported, or when stains and dust on touch panel 20 are wiped off.

Touch panel 20 is typically disposed on a front face typically of a liquid crystal display device (not illustrated), and mounted on an electronic device (not illustrated). A pair of upper electrodes and a pair of lower electrodes are then coupled to electronic circuit (not illustrated) of the electronic device via wiring board 19.

In the above structure, a top face of polarizing plate 28 is pressed, typically by a finger or pen, while the user views what is displayed on the liquid crystal display device disposed on a rear face of touch panel 20. This operation makes upper substrate 21 dent, together with polarizing plate 27 and upper wave plate 26, and upper conductive layer 23 and lower conductive layer 24 come into local contact at a portion pressed.

The electronic circuit then applies voltage sequentially to the upper electrodes and the lower electrodes. The electronic circuit detects a portion pressed based on the voltage ratio of the upper electrodes and the voltage ratio of the lower electrodes. This switches between the various functions of the electronic device.

External light, such as sunlight or lamplight irradiated from above touch panel 20, enters upper wave plate 26 after passing through polarizing plate 27. Since polarizing plate 27 has the characteristic of absorbing light waves in the Y direction, only the light linearly polarized in the X direction passes through polarizing plate 27 and enters upper wave plate 26, though the incident light including light waves in the X direction and light waves in the Y direction which is perpendicular to the X direction enters into polarizing plate 27.

The light entering upper wave plate 26 is then polarized from linearly polarized light to circularly polarized light as a result of passing through upper wave plate 26. This circularly polarized light is reflected upward on the surface of lower conductive layer 24.

The light reflected on the surface of lower conductive layer 24 passes through upper wave plate 26 again. The light is now linearly polarized in the Y direction which is shifted by a half-wavelength on entering polarizing plate 27. Since polarizing plate 27 only allows light waves in the X direction to pass through, polarizing plate 27 blocks any reflected light which is linearly polarized in the Y direction.

In other words, any external light entering touch panel 20 from above touch panel 20 is reflected upward on lower conductive layer 24. However, polarizing plate 27 blocks the reflected light, and thus this light does not exit from a top face of polarizing plate 27 which is the operation face. Accordingly, reflection of external light on the operation face is suppressed, allowing easily viewable characters or images to be seen typically on the liquid crystal display device on the rear face of touch panel 20. Touch panel 20 with good viewability is thus achieved.

Still more, for example, let's say the light generated from the display such as the liquid crystal display device disposed on the rear face of touch panel 20 is linearly polarized light in the Y direction. In this case, the light from the display device first passes through layer 29 and lower wave plate 28. The light passing through lower wave plate 28 then passes through upper wave plate 26. Consequently, the light which has passed through lower wave plate 28 and upper wave plate 26 becomes linearly polarized light in the X direction which is shifted by a half-wavelength on entering polarizing plate 27. The light then passes through polarizing plate 27 and exits from the top face of polarizing plate 27 which is the operation face.

Light waves to be absorbed by polarizing plate 27 are not limited to those in the Y direction. For example, light waves absorbed by polarizing plate 27 may be those in the X direction. Still more, the light from the liquid crystal display device is not limited to linearly polarized light in the Y direction. The light from the liquid crystal display device is determined depending on the configuration of polarizing plate 27, lower wave plate 28, and upper wave plate 26. For example, if polarizing plate 27 absorbs light waves polarized in the X direction, the light from the liquid crystal display device is preferably the linearly polarized light in the X direction.

More specifically, the light from the liquid crystal display device which is the light linearly polarized in the X direction becomes the light linearly polarized in the Y direction as it passes through lower wave plate 28 and upper wave plate 26. The light is only shifted by a half-wavelength, and exits from the top face of polarizing plate 27. Accordingly, what is displayed on the display such as the liquid crystal display device disposed on the rear face of touch panel 20 is clearly viewable, and reflection of external light from above touch panel 20 is also suppressed.

Still more, layer 29 is formed on the lower face of lower wave plate 28. Accordingly, the lower face of lower wave plate 28, which is made of a relatively soft material, is covered with rigid layer 29. This prevents any risk of damage to the lower face of lower wave plate 28 that may result when touch panel 20 is manufactured, stored, and transported, or when stains and dust attached to the surface of touch panel 20 are wiped off. As a result, good viewability of liquid crystal display device on the rear face of touch panel 20 can be retained.

As described above, the present invention readily achieves touch panel 20 which is resistant to damage that may occur to the lower face of lower wave plate 28 and provides good viewability.

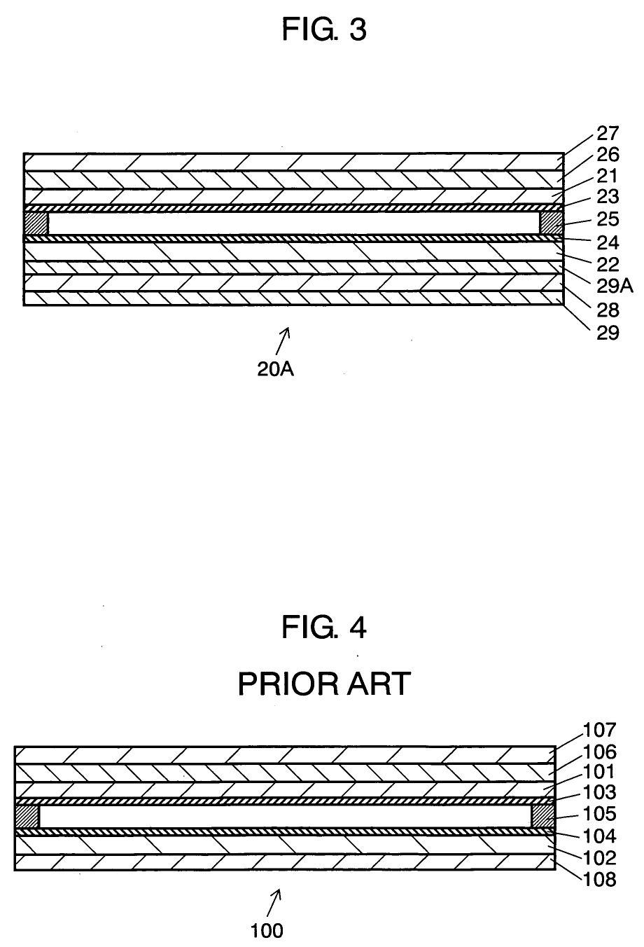

Still more, as shown in FIG. 3, second cover layer 29A (hereinafter referred to as ‘layer 29A’), which is a hard coating layer, may be provided on the top face of lower wave plate 28. Same as layer 29, layer 29A is light-transmissive and is typically made of acrylic resin. The hardness of layer 29A is also the same as layer 29, which has pencil hardness H to H2. Provision of layer 29A makes the top and lower faces of lower wave plate 28 sandwiched between layer 29A and layer 29. It is further preferable to provide layers 29A and 29 made of the same material, such that warpage of lower wave plate 28 can be suppressed when touch panel 20A is used in an ambient environment of high temperature and high humidity. Warpage of lower wave plate 28 can be further suppressed by providing layers 29A and 29 with substantially equal thickness.

For example, if lower wave plate 28 is warped, lower substrate 22 to which lower wave plate 28 is attached also warps. This reduces the space between lower conductive layer 24 and upper conductive layer 23. Accordingly, suppression of warpage of lower wave plate 28 ensures reliable electrical coupling and decoupling of lower conductive layer 24 and upper conductive layer 23. The present invention thus readily achieves touch panel 20A characterized by highly reliable operation.

What is claimed is:

1. A touch panel, comprising:
a light-transmissive upper substrate having an upper conductive layer formed at a lower face thereof;
a light-transmissive lower substrate having a lower conductive layer formed at a top face thereof, the lower conductive layer facing to the upper conductive layer with a predetermined space in between;
an upper wave plate formed at a top face of the upper substrate;
a polarizing plate formed at a top face of the upper wave plate;
a lower wave plate formed at a lower face of the lower substrate; and
a first cover layer formed at a lower face of the lower wave plate.

2. The touch panel of claim 1, further comprising:
a second cover layer formed at a top face of the lower wave plate.
